(19) United States
(12) Patent Application Publication
(10) Pub. No.: US 2021/0315312 A1
(43) Pub. Date: Oct. 14, 2021

(54) SPEAKER INTEGRATED INTO HELMET

(71) Applicant: Hamilton Sundstrand Corporation, Charlotte, NC (US)

(72) Inventor: Jake Rohrig, Simsbury, CT (US)

(21) Appl. No.: 17/223,608

(22) Filed: Apr. 6, 2021

Related U.S. Application Data
(60) Provisional application No. 63/006,953, filed on Apr. 8, 2020.

(51) Int. Cl. A42B 3/30; B64G 6/00; H04B 1/3827

(52) U.S. Cl. CPC A42B 3/30; H04B 2001/3866; H04B 1/385; B64G 6/00

(57) ABSTRACT

A helmet with an integrated speaker includes a first portion to attach to a mating ring. The first portion is shaped to create a volume for a head of a wearer. The helmet includes a second portion to attach to the mating ring. The first portion is entirely surrounded by the second portion without being in contact with the second portion and the second portion is farther from the volume than the first portion. One or more transducers are attached to the first portion. The one or more transducers receive an electrical signal representing an audio signal and the speaker is formed by the one or more transducers and the first portion.

### CROSS-REFERENCE TO RELATED APPLICATIONS

This application claims the benefit of U.S. Provisional Application 63/006,953 filed Apr. 8, 2020, the disclosure of which is incorporated herein by reference in its entirety.

### BACKGROUND

Exemplary embodiments pertain to the art of communication and, in particular, to a speaker integrated into a helmet.

In certain environments, a helmet is used not only for protection but also to maintain a specific environment for the wearer. In a deep space application, for example, the helmet that is part of the extravehicular mobility unit (i.e., space suit) contains gases to sustain the wearer. In a prior extravehicular mobility unit, in addition to this helmet, the wearer also wears a communications carrier assembly (CCA). The CCA is a cap worn directly on the head of the wearer, akin to a skull cap with a chin strap.

### BRIEF DESCRIPTION

In one embodiment, a helmet with an integrated speaker includes a first portion to attach to a mating ring. The first portion is shaped to create a volume for a head of a wearer. The helmet also includes a second portion to attach to the mating ring. The first portion is entirely surrounded by the second portion without being in contact with the second portion and the second portion is farther from the volume than the first portion. One or more transducers are attached to the first portion. The one or more transducers receive an electrical signal representing an audio signal and the speaker is formed by the one or more transducers and the first portion.

Additionally or alternatively, in this or other embodiments, the one or more transducers are bonded to an outer surface of the first portion in a space between the first portion and the second portion.

Additionally or alternatively, in this or other embodiments, the helmet also includes an amplifier to provide the electrical signal to each of the one or more transducers.

Additionally or alternatively, in this or other embodiments, the amplifier receives a receiver-provided electrical signal representing the audio signal from a radio frequency receiver, and the electrical signal is an amplified version of the receiver-provided electrical signal.

Additionally or alternatively, in this or other embodiments, the one or more transducers are acoustic transmitters or piezoelectric (PE) effectors.

Additionally or alternatively, in this or other embodiments, the one or more transducers is arranged on the first portion to induce vibration in the first portion in response to the electrical signal.

Additionally or alternatively, in this or other embodiments, the first portion and the second portion include a polycarbonate layer.

In another embodiment, an atmospheric suit with a speaker integrated into a helmet includes a first portion of the helmet to attach to a mating ring of the atmospheric suit. The first portion of the helmet is shaped to create a volume for a head of a wearer and the first portion creates an internal atmosphere of the atmospheric suit when attached to the mating ring. A second portion of the helmet attaches to the mating ring. The first portion of the helmet is entirely surrounded by the second portion of the helmet without being in contact with the second portion of the helmet and the second portion of the helmet is farther from the volume than the first portion of the helmet. One or more transducers are attached to the first portion of the helmet. The one or more transducers receive an electrical signal representing an audio signal and the speaker is formed by the one or more transducers and the first portion of the helmet.

Additionally or alternatively, in this or other embodiments, the one or more transducers are bonded to an outer surface of the first portion of the helmet in a space between the first portion of the helmet and the second portion of the helmet, and the one or more transducers are acoustic transmitters or piezoelectric (PE) effectors.

Additionally or alternatively, in this or other embodiments, the atmospheric suit also includes an amplifier to provide the electrical signal to each of the one or more transducers.

Additionally or alternatively, in this or other embodiments, the amplifier receives a receiver-provided electrical signal representing the audio signal from a radio frequency receiver. The electrical signal is an amplified version of the receiver-provided electrical signal.

Additionally or alternatively, in this or other embodiments, the one or more transducers is arranged on the first portion of the helmet to induce vibration in the first portion of the helmet in response to the electrical signal.

Additionally or alternatively, in this or other embodiments, the first portion of the helmet and the second portion of the helmet include a polycarbonate layer.

In yet another embodiment, a method of assembling a speaker includes attaching one or more transducers to a first portion of a helmet. The one or more transducers receive an electrical signal representing an audio signal. The method also includes attaching the first portion of the helmet to a mating ring to create a volume for the head of a wearer of the helmet, and attaching a second portion of the helmet to the mating ring such that the first portion of the helmet is entirely surrounded by the second portion of the helmet without being in contact with the second portion of the helmet. The second portion of the helmet is farther from the volume than the first portion of the helmet.

Additionally or alternatively, in this or other embodiments, the attaching the one or more transducers to the first portion of the helmet includes bonding the one or more transducers to an outer surface of the first portion of the helmet in a space between the first portion of the helmet and the second portion of the helmet.

Additionally or alternatively, in this or other embodiments, the method also includes arranging an amplifier to provide the electrical signal to each of the one or more transducers.

Additionally or alternatively, in this or other embodiments, the method also includes configuring the amplifier to receive a receiver-provided electrical signal representing the audio signal from a radio frequency (RF) receiver, wherein the electrical signal is an amplified version of the receiver-provided electrical signal.

Additionally or alternatively, in this or other embodiments, the attaching the one or more transducers includes attaching one or more acoustic transmitters or piezoelectric (PE) effectors.

Additionally or alternatively, in this or other embodiments, the attaching the one or more transducers to the first portion of the helmet includes arranging the one or more transducers to induce vibration in the first portion of the helmet in response to the electrical signal.

Additionally or alternatively, in this or other embodiments, the first portion of the helmet and the second portion of the helmet include a polycarbonate layer.

### BRIEF DESCRIPTION OF THE DRAWINGS

The following descriptions should not be considered limiting in any way. With reference to the accompanying drawings, like elements are numbered alike:

FIG. 1 shows aspects of an atmospheric suit with a speaker integrated into a helmet according to one or more embodiments; and

FIG. 2 is an exploded view of a helmet with integrated speakers according to one or more embodiments.

### DETAILED DESCRIPTION

A detailed description of one or more embodiments of the disclosed apparatus and method are presented herein by way of exemplification and not limitation with reference to the Figures.

As previously noted, certain applications require a helmet that maintains an internal environment for the wearer in addition to providing protection. One example is a helmet of an extravehicular mobility unit (i.e., space suit). In addition to this helmet, a wearer also wears a CCA as a cap fastened to the head according to a prior approach. The CCA includes headphones and microphones to facilitate communication to and from the wearer of the extravehicular mobility unit. The CCA, which is directly on the wearer's head, is below the helmet and between the wearer and the helmet. Thus, once in the extravehicular mobility unit, the wearer cannot adjust the CCA even if the headphones or microphones have shifted, for example. Shifting of the CCA can also be a safety hazard if the CCA rotates over the face of the wearer while in the suit. In addition, because the CCA is worn on the head, it must be sized for each wearer and is susceptible to degradation due to sweat. The CCA can interfere with in-helmet mechanisms, such as the straw from the in-suit drink bag (IDB).

Embodiments of the systems and methods detailed herein relate to a speaker integrated into a helmet. Generally, a speaker converts electrical energy to mechanical energy, and the mechanical energy to audible sound. According to exemplary embodiments, a portion of the helmet acts as a diaphragm of the speaker that vibrates in response to a transducer that induces vibration in response to an electrical signal. The vibration results in an audio output within the helmet. Exemplary applications for the helmet with an integrated speaker according to one or more embodiments include deep space (e.g., in an extravehicular mobility unit or space suit), underwater (e.g., in an atmospheric diving suit), earth-based (e.g., in a hazmat suit or contamination suit), high-altitude (e.g., in a flight suit), and sub-surface applications. Generally, the suit that mates to the helmet is referred to as an atmospheric suit.

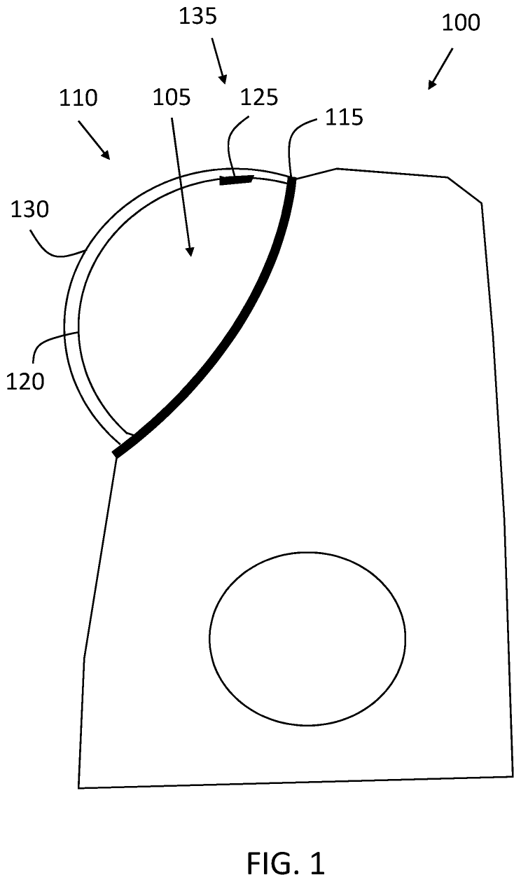

FIG. 1 shows aspects of an atmospheric suit 100 with a speaker 135 integrated into a helmet 110 according to one or more embodiments. As previously noted, the atmospheric suit 100 may be an extravehicular mobility unit used in a deep space application as one example. Alternately, the helmet 110 may be part of a different atmospheric suit 100 employed in underwater, earth-based, high-altitude, or sub-surface applications. The helmet 110 provides a volume 105 to accommodate the head of a wearer of the atmospheric suit 100. The helmet 110 includes an inner bubble 120 that maintains the gasses of the atmospheric suit 100 to create an environment to sustain the wearer. An outer bubble 130 is used to deflect or withstand impact forces, protecting the inner bubble 120.

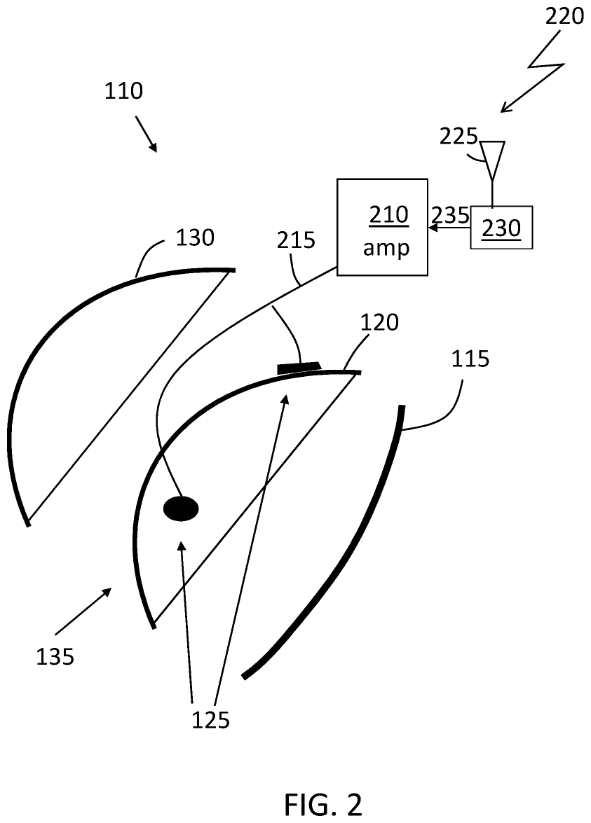

In space suit applications, the inner bubble 120 and the outer bubble 130 are both polycarbonate layers and, as such, are optically transparent. The inner bubble 120 and the outer bubble 130 are mated to the atmospheric suit 100 via a mating ring 115. An exemplary speaker 135 includes a transducer 125 bonded to the surface of the inner bubble 120 in the space between the inner bubble 120 and the outer bubble 130. The transducer 125, which converts an electrical signal into mechanical energy resulting in an audible output, may include an acoustic transmitter or a piezoelectric (PE) effector, for example. The speaker 135 is formed by a combination of the transducer 125 and the inner bubble 120, which functions as a diaphragm. The acoustic output provided to the wearer of the helmet 110 is further discussed with reference to FIG. 2.

FIG. 2 is an exploded view of a helmet 110 with an integrated speaker 135 according to one or more embodiments. Continuing reference is made to FIG. 1. The mating ring 115, inner bubble 120, and outer bubble 130 are shown. Two transducers 125 are shown bonded to the outer surface of the inner bubble 120. As indicated in FIG. 2, the inner bubble 120 and the transducers 125 form the speaker 135 integrated into the helmet 110. A wire 215 is shown between an amplifier 210 and the transducers 125. The wire 215 conveys an amplified electrical signal from the amplifier 210 to the transducers 125. The amplified electrical signal from the amplifier 210, which represents an audio signal, is converted to mechanical energy by the transducers 125 that are attached to the inner bubble 120. The output of the transducers 125 induces vibration of the inner bubble 120 (i.e., diaphragm of the speaker 135), creating pressure waves resulting in sound within the volume 105. In the exemplary case of the transducers 125 including PE effectors, the amplified electrical signal from the amplifier 210 is converted to vibration output by the PE effectors. This, in turn, induces vibration of the inner bubble 120, with the inner bubble 120 acting as a diaphragm, providing acoustic output corresponding with the electrical signal 220 to the wearer of the helmet 110.

The amplifier 210 generates the amplified electrical signal from an electrical signal 235 received from a radio frequency (RF) receiver 230. That is, the amplifier 210 increases the strength of the electrical signal 235. The RF receiver 230 includes an antenna 225 that receives an RF signal 220. The RF signal 220 may have been transmitted from another atmospheric suit 100, for example. Any of the wires 215, amplifier 210, and RF receiver 230 may be disposed within or outside the atmospheric suit 100. When the atmospheric suit 100 is filled with oxygen, as in the case of an extravehicular mobility unit, for example, the option to move all electrical components outside the atmospheric suit 100 can improve safety.

The RF signal 220 carries an audio signal that ultimately creates the sound in the volume 105 based on the pressure waves created by vibration of the inner bubble 120. The RF receiver 230 may include a tuner that selects the desired RF signal 220 from a group of received signals and a detector that extracts the audio signal from the RF signal 220. Then, the RF receiver 230 sends the audio signal that was carried by the RF signal 220 as an electrical signal 235 that is amplified by the amplifier 210. As previously noted, the electrical energy from the amplifier 210 to the transducers 125 (e.g., over the wires 215) represents the audio signal. According to an alternate embodiment, each transducer 125 may include a power supply, antenna, receiver, and amplifier. As such, the RF signal 220 may be received wirelessly at the transducer 125.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A helmet with an integrated speaker, the helmet comprising:
a first portion configured to attach to a mating ring, wherein the first portion is shaped to create a volume for a head of a wearer;
a second portion configured to attach to the mating ring, wherein the first portion is entirely surrounded by the second portion without being in contact with the second portion and the second portion is farther from the volume than the first portion; and
one or more transducers attached to the first portion, wherein the one or more transducers are configured to receive an electrical signal representing an audio signal and the speaker is formed by the one or more transducers and the first portion.

2. The helmet according to claim 1, wherein the one or more transducers are bonded to an outer surface of the first portion in a space between the first portion and the second portion.

3. The helmet according to claim 1, further comprising an amplifier configured to provide the electrical signal to each of the one or more transducers.

4. The helmet according to claim 3, wherein the amplifier is configured to receive a receiver-provided electrical signal representing the audio signal from a radio frequency receiver, and the electrical signal is an amplified version of the receiver-provided electrical signal.

5. The helmet according to claim 1, wherein the one or more transducers are acoustic transmitters or piezoelectric (PE) effectors.

6. The helmet according to claim 1, wherein the one or more transducers is arranged on the first portion to induce vibration in the first portion in response to the electrical signal.

7. The helmet according to claim 1, wherein the first portion and the second portion include a polycarbonate layer.

8. An atmospheric suit with a speaker integrated into a helmet, the atmospheric suit comprising:
a first portion of the helmet configured to attach to a mating ring of the atmospheric suit, wherein the first portion of the helmet is shaped to create a volume for a head of a wearer and the first portion creates an internal atmosphere of the atmospheric suit when attached to the mating ring;
a second portion of the helmet configured to attach to the mating ring, wherein the first portion of the helmet is entirely surrounded by the second portion of the helmet without being in contact with the second portion of the helmet and the second portion of the helmet is farther from the volume than the first portion of the helmet; and
one or more transducers attached to the first portion of the helmet, wherein the one or more transducers are configured to receive an electrical signal representing an audio signal and the speaker is formed by the one or more transducers and the first portion of the helmet.

9. The atmospheric suit according to claim 8, wherein the one or more transducers are bonded to an outer surface of the first portion of the helmet in a space between the first portion of the helmet and the second portion of the helmet, and the one or more transducers are acoustic transmitters or piezoelectric (PE) effectors.

10. The atmospheric suit according to claim 8, further comprising an amplifier configured to provide the electrical signal to each of the one or more transducers.

11. The atmospheric suit according to claim 10, wherein the amplifier is configured to receive a receiver-provided electrical signal representing the audio signal from a radio frequency receiver, and the electrical signal is an amplified version of the receiver-provided electrical signal.

12. The atmospheric suit according to claim 8, wherein the one or more transducers is arranged on the first portion of the helmet to induce vibration in the first portion of the helmet in response to the electrical signal.

13. The atmospheric suit according to claim 8, wherein the first portion of the helmet and the second portion of the helmet include a polycarbonate layer.

14. A method of assembling a speaker, the method comprising:
attaching one or more transducers to a first portion of a helmet, wherein the one or more transducers are configured to receive an electrical signal representing an audio signal;
attaching the first portion of the helmet to a mating ring to create a volume for the head of a wearer of the helmet; and
attaching a second portion of the helmet to the mating ring such that the first portion of the helmet is entirely surrounded by the second portion of the helmet without being in contact with the second portion of the helmet, wherein the second portion of the helmet is farther from the volume than the first portion of the helmet.

15. The method according to claim 14, wherein the attaching the one or more transducers to the first portion of the helmet includes bonding the one or more transducers to an outer surface of the first portion of the helmet in a space between the first portion of the helmet and the second portion of the helmet.

16. The method according to claim 14, further comprising arranging an amplifier to provide the electrical signal to each of the one or more transducers.

17. The method according to claim 16, further comprising configuring the amplifier to receive a receiver-provided electrical signal representing the audio signal from a radio frequency (RF) receiver, wherein the electrical signal is an amplified version of the receiver-provided electrical signal.

18. The method according to claim 14, wherein the attaching the one or more transducers includes attaching one or more acoustic transmitters or piezoelectric (PE) effectors.

19. The method according to claim 14, wherein the attaching the one or more transducers to the first portion of the helmet includes arranging the one or more transducers to induce vibration in the first portion of the helmet in response to the electrical signal.

20. The method according to claim 14, wherein the first portion of the helmet and the second portion of the helmet include a polycarbonate layer.
